(19) United States
(12) Patent Application Publication
(10) Pub. No.: US 2008/0224591 A1
(43) Pub. Date: Sep. 18, 2008

(54) Low-Pressure Mercury Discharge Lamp and Process for Its Preparation

(75) Inventor: Petrus Wilhelmus Vincentius Kop, Roosendaal (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,245

(22) PCT Filed: Jan. 19, 2005
(86) PCT No.: PCT/IB2005/050215

§ 371 Date: Jul. 18, 2006

(30) Foreign Application Priority Data
Jan. 23, 2004 (EP) 04100228.8

(51) Int. Cl. H01J 1/62; H01J 9/02

(52) U.S. Cl. 313/487; 445/26

(57) ABSTRACT

The invention relates to a low-pressure mercury discharge lamp comprising an envelope with an inner surface enclosing a discharge space in which a mercury comprising filling is accommodated, at least one electrode for generating ultraviolet radiation in said discharge space, and a phosphor layer formed over said inner surface to convert said ultraviolet radiation into light of the green wavelength region, wherein said phosphor layer consists of a water-dispersable blend of a yellow-green phosphor and a blue-green phosphor. The blend consists preferably of the CBT and BAM-green phosphors.

The invention relates to a low-pressure mercury discharge lamp comprising an envelope with an inner surface enclosing a discharge space in which a mercury comprising filling is accommodated, at least one electrode for generating ultraviolet radiation in said discharge space, and a phosphor layer formed over said inner surface to convert said ultraviolet radiation into light of the green wavelength region.

Such a lamp is commercially available from Applicant as a TLD lamp of color 17. The phosphor layer present in this known lamp consists of the green phosphor zinc silicate, activated with manganese, also known as willemite.

The disadvantage of willemite is that it must be applied as a butyl acetate suspension, it is not-suitable for water based suspensions.

It would nevertheless be desirable to coat the lamps with an aqueous phosphor suspension, so that the processing can be executed more environmentally friendly, and the cost price can be reduced.

A phosphor layer composition has now been found which eliminates the drawbacks of willemite.

The low-pressure mercury discharge lamp according to the invention is, more specifically, characterized in that said phosphor layer consists of a water-dispersable blend of a yellow-green phosphor and a blue-green phosphor.

A further advantage of such a phosphor blend is that the color of the lamp, which is provided in operation, can be tuned, if so desired by customers, i.e. by providing a yellowish or a blueish impression to the basic green color, simply by changing the proportion of the relevant phosphor in the blend.

It was further surprisingly found that the present phosphor layer can provide a light output of at least 3600 lumens at an operation life of 100 h. This is a large improvement compared with a lamp containing willemite, which has a light output of only 1600 lumens at an operation life of 100 h.

Preferred blends of phosphors to be used in a lamp according to the invention are claimed in claims 3 and 4.

It is observed that a green fluorescent material consisting of a mixture of a first green phosphor and a second green phosphor is as such known from JP 2002-038147. The first green phosphor, nevertheless, comprises a manganese-activated aluminate salt phosphor and the second phosphor comprises a manganese-activated zinc silicate phosphor, according to this reference. Both phosphors are thus only green phosphors, not a combination of a yellow-green and a blue-green phosphor as used in the present invention.

Further, the use of the phosphors GdMg borate activated by cerium and terbium, and BaMg aluminate, activated by bivalent europium, as components of a luminescent material for lamps, is known from WO98/08916.

The last-mentioned known phosphor BaMg aluminate:Eu²⁺ is nevertheless different from a blue-green phosphor as used in the invention in that it is not activated by manganese, and is thus only a blue phosphor. A combination of a yellow-green phosphor and a blue-green phosphor as disclosed in the present invention is thus also not known from WO98/08916.

An additional advantage of the presence of the blend of the two phosphors in a low-pressure mercury discharge lamp, is that antimony (III) oxide, as constituent in the discharge space, can, surprisingly, be omitted. Antimony (III) oxide is usually added for providing a sufficient maintenance value of the lamp. It now appeared, as will be explained hereafter, that maintenance values of up to 90%, or even up to 98%, at 5000 h in operation, could be obtained by using a blend of phosphors in a low-pressure mercury discharge lamp, in the absence of antimony (III) oxide.

Further features and advantages of the invention will become more readily, apparent from a consideration of the following detailed description set forth with reference to the accompanying drawing, which specifies and shows a preferred embodiment of the invention, and in which:

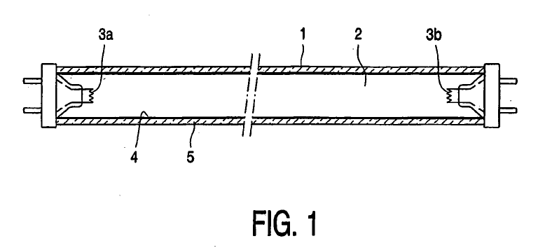

FIG. 1 shows a low-pressure mercury discharge lamp according to the invention.

FIG. 1 shows a low-pressure mercury discharge lamp which is provided with a discharge vessel 1 which encloses a discharge space 2 in a vacuum-tight manner and in which a filling is accommodated comprising mercury and argon. The discharge vessel 1 here is a lime glass tube with an electrode 3a, 3b arranged therein at either end. The electrodes serve as means for maintaining an electric discharge in the discharge space 2. The discharge vessel 1 is provided with a luminescent layer 5 on an inner surface 4. The luminescent layer 5 of the lamp according to the invention only contains the phosphors GdMgB₅O₁₀:Ce, Tb (hereafter also called “CBT”) and BaMgAl₁₀O₁₇:Eu, Mn (hereafter also called “BAM-green”).

The phosphor blend was applied on the inside of the lamp by means of an aqueous suspension.

Suspensions having a composition of CBT/BAM-green of 87/13%, 75/25% and 50/50% respectively, were applied. Thus produced low-pressure mercury discharge lamps were subjected to different tests; the results thereof are given in the following table.

Further, a low-pressure mercury discharge lamp having wiliemite as the only phosphor, and applied as a suspension in butyl acetate, was produced and subjected to the same tests, as a reference product.

To complete the tested range of materials, lamps, whereof the phosphor layer consisted of only CBT and of only BAM-green, were produced and tested. The results of the tests of these lamps are also given in the following table.

| | TABLE | | | | | |
|---|---|---|---|---|---|---|
| | Phosphor | | | | | |
| | | | CBT/Bam- | CBT/Bam- | CBT/Bam- | |
| | Willemite | | green | green | green | |
| Properties: | (reference) | CBT | (87%/13%) | (75%/25%) | (50%/50%) | Bam-green |
| Visual impression | Yellow-green | Yellow-green | Yellow-green | More green | More green | Blue-green |
| | | | | related to | related to | related to |
| | | | | reference | reference | reference |
| Light output at | 1600 | 4560 | ← in between → | | | 3800 |
| 100 h [lm] | | | | | | |
| Average | 47% | 94% | ← in between → | | | 90-94% |
| maintenance at | | | | | | |
| 5000 h | | | | | | |
| Spread on light | Very large | Low | Low | Low | Low | Low |
| output and | | | | | | |
| maintenance | | | | | | |
| X/Y | .247/.620 | .315/.536 | ← in between → | | | .150/.556 |
| X/Y control | Very simple | Very simple | Simple | Simple | Simple | Very simple |
| Coating | Very coarse | Smooth | Smooth | Smooth | Smooth | Smooth |
| appearance | | | | | | |

It appears from the results given in the table, that lamps containing a phosphor blend according to the invention had an average maintenance which varied between 90% and 98%, whereas the average maintenance of a lamp having willemite as the green phosphor had a maintenance which varied between 34% and 64%, so at average 47%.

Due to the high values of the maintenance at 5000 h for the lamps according to the invention, it is no longer necessary to add antimony (III) oxide to the phosphor coating of the lamp. Moreover, the light output at 100 h is considerably higher for a blend of phosphors according to the invention, compared with the known green phosphor willemite.

Further, the visual impression of the lamp in operation can be adapted to comply with the costumers' request, by simply changing the composition of the phosphor blend. Because the present blend of phosphors can be deposited on the wall of the lamp as an aqueous suspension, the process control will be improved and the logistic being simpler, which will result in a cost price reduction.

While the present invention has been described in particular detail, it should be appreciated that numerous modifications are possible within the intended spirit and scope of the invention, the scope of the invention being indicated by the appended claims rather than by the foregoing description.

1. A low-pressure mercury discharge lamp comprising an envelope with an inner surface enclosing a discharge space in which a mercury comprising filling is accommodated, at least one electrode for generating ultraviolet radiation in said discharge space, and a phosphor layer formed over said inner surface to convert said ultraviolet radiation into light of the green wavelength region, wherein said phosphor layer consists of a water-dispersable blend of a yellow-green phosphor and a blue-green phosphor.

2. A low-pressure mercury discharge lamp according to claim 1, wherein said phosphor layer provides a light output of at least 3600 lumens at an operation life of 100 h.

3. A low-pressure mercury discharge lamp according to claim 1, wherein said yellow-green phosphor is a Ce, Tb activated phosphor, preferably gadolinium magnesium borate, activated by Ce, Tb; and wherein said blue-green phosphor is a Eu, Mn activated phosphor, preferably barium magnesium aluminate, activated by Eu, Mn.

4. A low-pressure mercury discharge lamp according to claim 1, wherein the weight ratio of yellow-green phosphor to blue-green phosphor is from 90:10 to 10:90, preferably 75:25 to 50:50.

5. A process for the preparation of a low-pressure mercury discharge lamp having green emission, comprising the application of a green-emitting phosphor layer on the inner surface of the envelope enclosing the discharge space of the lamp, wherein an aqueous suspension of a blend of a yellow-green phosphor and a blue-green phosphor is deposited on the inner surface, followed by drying to obtain a coating of a green phosphor layer on said inner surface.

6. A process according to claim 5, wherein said phosphor blend consists of a Ce, Tb activated gadolinium magnesium borate and a Eu, Mn activated barium magnesium aluminate, preferably in a proportion of 87-50% b.w. of gadolinium magnesium borate, activated by Ce or Th, to 13-50% b.w. of barium magnesium aluminate, activated by Eu and Mn.
